(19) United States
(12) Patent Application Publication
(10) Pub. No.: US 2003/0010811 A1
(43) Pub. Date: Jan. 16, 2003

(54) Hollow-pipe forming apparatus and its products

(76) Inventor: Ching-Chi Chung, Ping-Tung (TW)

Correspondence Address: DOUGHERTY & TROXELL, SUITE 1404, 5205 LEESBURG PIKE, FALLS CHURCH, VA, 22041, US

(21) Appl. No.: 09/904,854

(22) Filed: Jul. 16, 2001

(51) Int. Cl. B23K 31/02; B23K 1/20

(52) U.S. Cl. 228/173.7; 228/173.6

(57) ABSTRACT

The present invention is a hollow-pipe forming apparatus and its products, which mainly comprises a driving mechanism, a fuse-welding mechanism and a feeding mechanism etc. The driving mechanism connects with a cylindrical internal mold at an output end of a driver, with the outside diameter of the internal mold being equal to the inside diameter of the pipe to be produced. The fuse-welding mechanism is a general fuse-welding machine, which has a welding gun. The feeding mechanism supports a metal strip thereon, and the metal strip is caused to pass through a leveling and fixing rack and overlap onto the internal mold of the driving mechanism after being unrolled, so that the leveling and fixing rack can exert a stretching and leveling effect on the metal strip. When the metal strip is overlapped onto the internal mold, it will form an angle between it and the internal mold. Therefore, the metal strip on the feeding mechanism can overlap onto the internal mold of the driving mechanism in an appropriate angle. Then the driver is activated to rotate the internal mold, so that the metal strip is wrapped into a round pipe shape and the edges of the metal strip are caused to be adjacent each other. Meanwhile, the welding gun of the fuse-welding mechanism applies a fuse-welding operation on the adjacent portion of the titan-metal strip, so as to form a hollow pipe.

### FIELD OF THE INVENTION

The present invention relates to a hollow-pipe forming apparatus and its products, especially to a hollow-pipe forming apparatus and its products, in which the metal sheet is fuse-welded in a spiral way, to form a hollow pipe and cause the pipe having a higher strength and being not liable to deform, and to increase the flow rate of the liquid when the pipe is used to convey liquid.

### PRIOR ART

Referring to FIG. 1 and 2, a hollow pipe 10 (i.e. a seam pipe) which is generally produced by fuse-welding (or welding) is formed by a metal sheet 11 via a rolling machine in a rolling and pressing procedure, to give the planar metal sheet 11 a circular tube shape, and then the two adjoining ends of the metal sheet 11 that has been rolled into a circular shape are subjected to a fuse-welding operation, to weld the sheet into an integrated hollow pipe 10. However, it has been found that, in the hollow pipe 10 produced by the above-mentioned way, a welding seam 12 formed in the fuse-welding procedure extends along a straight line, and the welding seam 12 is the most weak portion in the whole hollow pipe 10. Therefore, the hollow pipe 10 is very likely to deform in the fuse-welded portion, and the deformation is even more likely to occur when the hollow pipe 10 is formed long. Further, when the hollow pipe 10 is used as a liquid conveying pipe, the pipe can provide a flow inside the pipe, but the flow rate can not be improved.

### SUMMARY OF THE INVENTION

An object of the invention is to avoid the problems and the disadvantages presented in the hollow pipes formed by above-mentioned fuse-welding way, and to create a hollow-pipe forming apparatus and its products, in which the metal sheet is fuse-welded in a spiral way, to form a hollow pipe and cause the pipe having a higher strength and being not liable to deform, and to increase the flow rate of the liquid when the pipe is used to convey liquid.

### BRIEF DESCRIPTION OF DRAWINGS

FIG. 1 is a schematic view for explaining the hollow-pipe roll forming of the prior art.

FIG. 2 is a perspective view of a hollow pipe of the prior art.

FIG. 3 is a schematic view for explaining the hollow-pipe forming of the invention.

FIG. 4 is a perspective view of a hollow pipe of the invention.

FIG. 5 is a perspective view of another embodiment of the invention.

FIG. 6 is a sectional view taken along line I-I of FIG. 5.

FIG. 7 is a perspective view of another hollow pipe of the present invention.

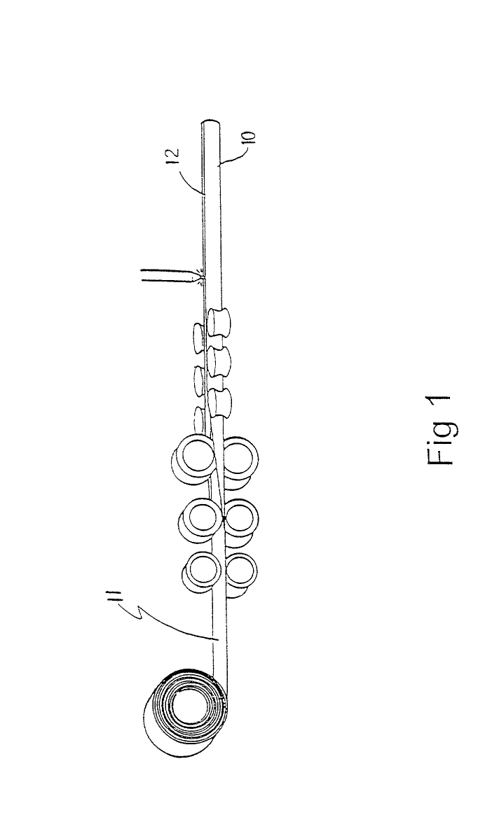

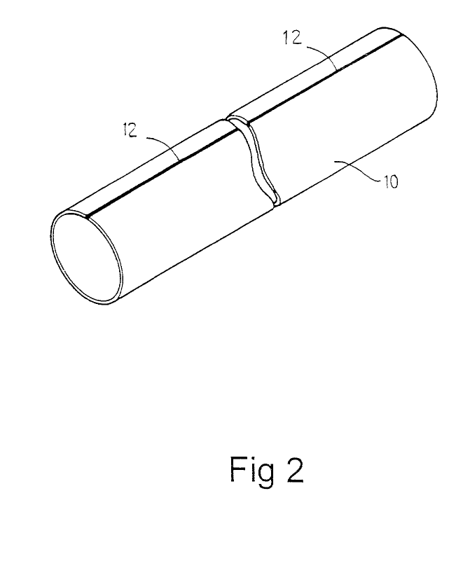

Notations:

| | |
|---|---|
| Prior art: | |
| 10 hollow pipe | 11 metal sheet |
| 12 welding seam | |
| Present invention: | |
| 20 driving mechanism | 21 driver |
| 22 output end | 23 internal mold |
| 24 chamfer | 25 recess |
| 30 fuse-welding mechanism | 31 welding gun |
| 40 feeding mechanism | 41 metal strip |
| 42 leveling and fixing rack | 43 flange |
| 50 hollow pipe | 51 welding seam |
| 60 hollow pipe | 61 welding seam |

### DESCRIPTION OF THE INVENTION

Now the technical method for attaining the object of the present invention is described in details with reference to the embodiments shown in the drawings as follow.

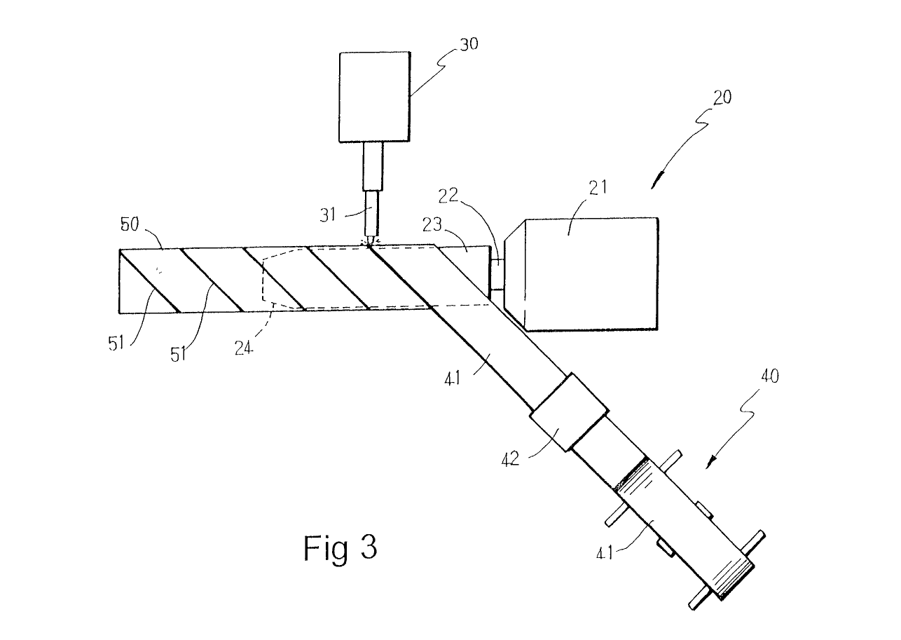

Referring to FIG. 3, the present invention is mainly comprised of a driving mechanism 20, a fuse-welding mechanism 30 and a feeding mechanism 40 etc., wherein:

The driving mechanism 20 (as shown in FIG. 3) connects with a cylindrical internal mold 23 at an output end 22 of a driver 21. The outside diameter of the internal mold 23 is equal to the inside diameter of the pipe to be produced. Therefore, the internal mold 23 can be of different sizes and can be exchanged and connected to the output end 22 of the driver 21. The front end of the internal mold 23 provides a chamfer 24 of an appropriate inclination angle.

The fuse-welding mechanism 30 (as shown in FIG. 3) is a general fuse-welding machine, which has a welding gun 31.

The feeding mechanism 40 (as shown in FIG. 3) supports a metal strip 41 thereon, and the metal strip 41 is caused to pass through a leveling and fixing rack 42 and overlap onto the internal mold 23 of the driving mechanism 20 after being unrolled, so that the leveling and fixing rack 42 can exert a stretching and leveling effect on the titan-metal strip 41. When the metal strip 41 is overlapped onto the internal mold 23, an angle which is preferably 45 degrees is formed between the metal strip 41 and the internal mold 23.

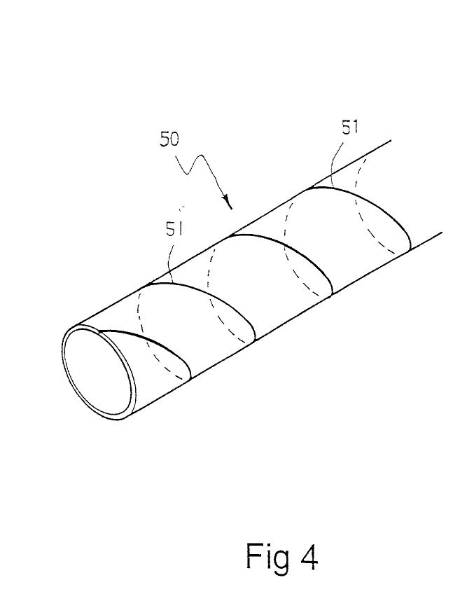

By using the structure formed by above-mentioned way (as shown in FIG. 4), the metal strip 41 on the feeding mechanism 40 can be caused to pass through the leveling and fixing rack 42 and overlap onto the internal mold 23 of the driving mechanism 20. Then the driver 21 is activated to rotate the internal mold 23, so that the metal strip 41 is wrapped into a round pipe shape and the edges of the metal strip 41 are cause to be adjacent each other. Meanwhile, the welding gun 31 of the fuse-welding mechanism 30 applies a fuse-welding operation on the adjacent portion of the metal strip 41, so as to fuse-weld and integrate the metal strip 41 that has been wrapped into a round pipe shape to form a hollow pipe 50. Therefore, A welding seam 51 of the hollow pipe 50 has a spiral shape. After formed by fuse-welding, the hollow pipe 50 is drew off the internal mold 23 by a discharge drawing mechanism, which operates in coordination with the rotate velocity of the driver 21 (the discharge drawing mechanism is not a major aspect of the invention and will not described here). Then, the hollow pipe 50 will undergo a cutting process and the like, so that the pipes of desired length will obtained.

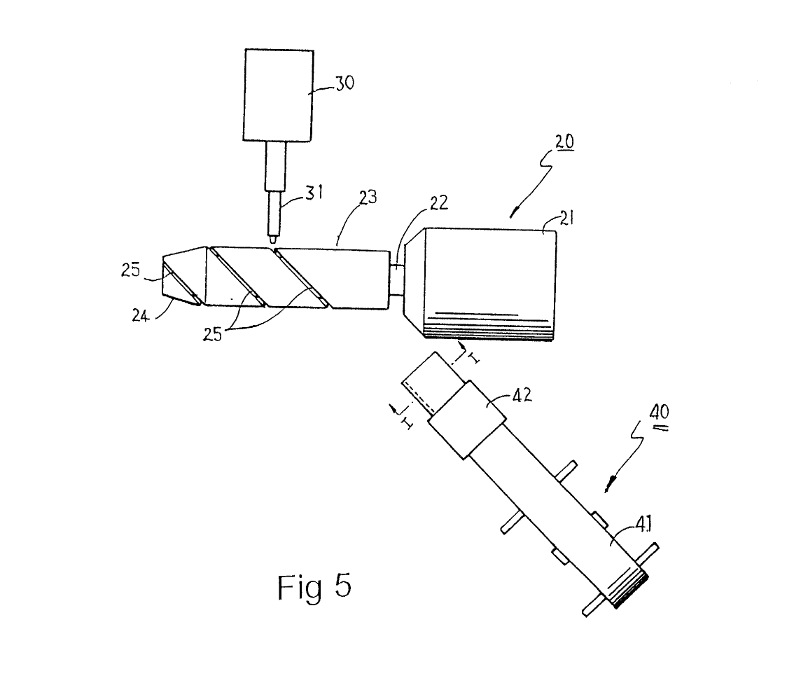

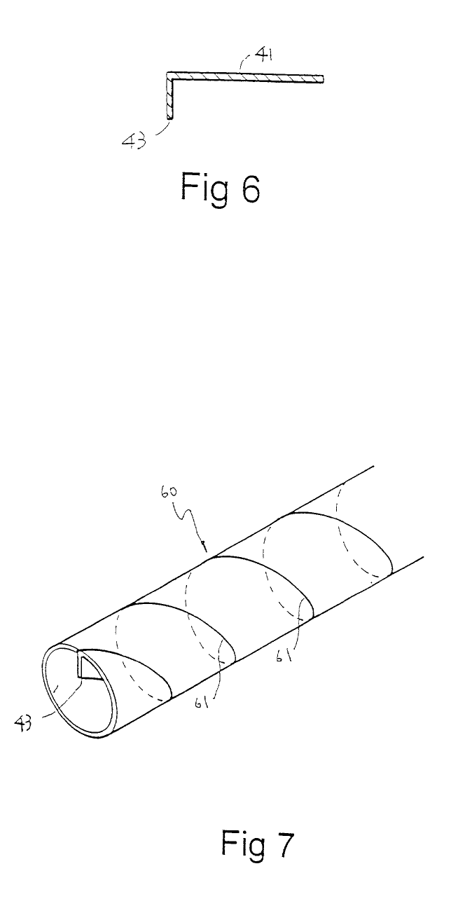

Further (as shown in FIG. 5 and 6), the internal mold 23 of said driving mechanism 20 can be provide with a spiral recess 25 of an appropriate depth, and the metal strip 41 on the feeding mechanism 40 is formed by a metal having a better extensibility. A side edge of the strip is bent downwardly to become a flange 43, which can be formed by rolling or by pressing. Therefore (as shown in FIG. 7), when the metal strip 41 with a flange 43 passes through the leveling and fixing rack 42 and overlaps onto the internal mold 23 of the driving mechanism 20, the flange 43 is caused to align with the recess 25 of the internal mold 23 of the driving mechanism 20. Then the driver 21 is activated to rotate the internal mold 23, so that the metal strip 41 is wrapped to form a hollow pipe 60, a welding seam 61 of which having a spiral shape. The flange 43 is extended inwardly and spirally along the welding seam 61, to form a rib for further reinforcing the hollow pipe 60. In addition able to uniform the stress in the hollow pipe 60 and increase the strength of the hollow pipe 60 for decreasing the deformation, said flange 43 also forms a protruding spiral rib inside the hollow pipe 60. So, when the hollow pipe 60 is used as a liquid conveying pipe, the flange 43 inside the pipe will form a spiral passage, so as to cause the liquid in the pipe being conveyed in a spiral flowing way, to increase the flow rate of the liquid. Moreover, though the metal strip 41 is an L-shaped sheet material and will generate a resistance when rotated by the internal mold 23, but the metal strip 41 is formed by a metal having a better extensibility, and the metal molecules will be transformed by the high temperature generated during the fuse-welding operation, so that the strip can be wrapped smoothly without deformation.

1. A hollow-pipe forming apparatus and its products, mainly comprising a driving mechanism, a fuse-welding mechanism and a feeding mechanism etc., wherein:
the driving mechanism connects with a cylindrical internal mold at an output end of a driver, with the outside diameter of the internal mold being equal to the inside diameter of the pipe to be produced;
the fuse-welding mechanism is a general fuse-welding machine, which has a welding gun;
the feeding mechanism supports a metal strip thereon, and the metal strip is caused to pass through a leveling and fixing rack and overlap onto the internal mold of the driving mechanism after being unrolled, so that the leveling and fixing rack can exert a stretching and leveling effect on the metal strip, and when the metal strip is overlapped onto the internal mold, it will form an angle between it and the internal mold,
therefore, the titan-metal strip on the feeding mechanism can overlap onto the internal mold of the driving mechanism in an appropriate angle, then the driver is activated to rotate the internal mold, so that the titan-metal strip is wrapped into a round pipe shape and the edges of the titan-metal strip are caused to be adjacent each other; meanwhile, the welding gun of the fuse-welding mechanism applies a fuse-welding operation on the adjacent portion of the titan-metal strip, so as to form a hollow pipe.

2. The hollow-pipe forming apparatus and its products as recited in claim 1, wherein the internal mold of said driving mechanism is provide with a spiral recess; the metal strip on the feeding mechanism is formed by a metal having a better extensibility, and a side edge of the strip is bent downwardly to form a flange;
when the metal strip overlaps onto the internal mold of the driving mechanism after being unrolled, the flange is caused to align with the recess of the internal mold; therefore, when the strip is wrapped and welded into a hollow pipe, a spiral flange will extend on the underside of its welding seam.

3. The hollow-pipe forming apparatus and its products as recited in claim 1, wherein the front end of the internal mold of the driving mechanism provides a chamfer of an appropriate inclination angle, to facilitate the fuse-welded pipe stripping off the internal mold.
